(19) United States
(12) Patent Application Publication
(10) Pub. No.: US 2013/0075032 A1
(43) Pub. Date: Mar. 28, 2013

(54) METHOD OF MANUFACTURING THREE-DIMENSIONAL IMAGE DISPLAY DEVICE

(71) Applicant: Shinji ICHIDA, Yokohama-shi (JP)

(72) Inventor: Shinji ICHIDA, Yokohama-shi (JP)

(21) Appl. No.: 13/609,820

(22) Filed: Sep. 11, 2012

(30) Foreign Application Priority Data
Sep. 26, 2011 (JP) 2011-208427

(51) Int. Cl. B32B 37/14; B32B 37/12

(52) U.S. Cl. 156/275.7; 156/292

(57) ABSTRACT

According to one embodiment, a method of manufacturing a three-dimensional image display device includes, supplying an adhesive member to a lens plate, and a display panel configured to display an image in a frame shape including a discontinuous part in such a manner that an aperture is formed in a state where the lens plate and the display panel are adhered together, adhering the lens plate, and the display panel together through the adhesive member with the lenticular lens directed to the display panel, and sealing the aperture by supplying an adhesive to the aperture in a reduced pressure atmosphere in the state where the lens plate and the display panel are adhered together, the pressure of the reduced pressure atmosphere being raised after the sealing.

### CROSS-REFERENCE TO RELATED APPLICATIONS

This application is based upon and claims the benefit of priority from Japanese Patent Application No. 2011-208427, filed Sep. 26, 2011, the entire contents of which are incorporated herein by reference.

### FIELD

Embodiments described herein relate generally to a method of manufacturing a three-dimensional image display device.

### BACKGROUND

A three-dimensional image display device provided with a lenticular lens as a display panel of the three-dimensional image display device has been developed. In the manufacturing method of the three-dimensional image display device of this kind, when the lenticular lens is to be attached to the display panel, a lens plate including the lenticular lens is adhered to the display panel with an adhesive applied to the display panel in a rectangular frame-like shape.

In order to control the distance between the display panel and lenticular lens with high accuracy, the display panel and lens plate are adhered together in a pressure-reduced atmosphere with the frame-shaped adhesive member in a state where the lenticular lens is directed to the display panel.

### BRIEF DESCRIPTION OF THE DRAWINGS

FIG. 1 is a cross-sectional view showing the schematic configuration of a three-dimensional image display device according to a first embodiment.

FIG. 2 is a flowchart showing a manufacturing method of the three-dimensional image display device.

FIG. 3 is a block diagram showing a manufacturing equipment of the three-dimensional image display device.

FIG. 4 is an explanatory view showing an application process in the manufacturing method.

FIG. 5 is an explanatory view showing the state of an adhesive member after the application process in the manufacturing method.

FIG. 6 is an explanatory view showing an adhesion process in the manufacturing method.

FIG. 7 is an explanatory view showing a pressure reduction process in the manufacturing method.

FIG. 8 is an explanatory view showing the state of an aperture in the manufacturing method.

FIG. 9 is a flowchart showing a manufacturing method of a three-dimensional image display device according to a second embodiment.

FIG. 10 is a block diagram showing a manufacturing equipment of the three-dimensional image display device.

FIG. 11 is an explanatory view showing the state of an aperture in the manufacturing method.

### DETAILED DESCRIPTION

In general, according to one embodiment, a method of manufacturing a three-dimensional image display device comprises, supplying an adhesive member to at least one of a lens plate including a lenticular lens, and a display panel configured to display an image in a frame shape including a discontinuous part in such a manner that an aperture is formed in a state where the lens plate and the display panel are adhered together, adhering the lens plate, and the display panel together through the adhesive member with the lenticular lens directed to the display panel, and sealing the aperture by supplying an adhesive to the aperture in a reduced pressure atmosphere in the state where the lens plate and the display panel are adhered together, the pressure of the reduced pressure atmosphere being raised after the sealing.

### First Embodiment

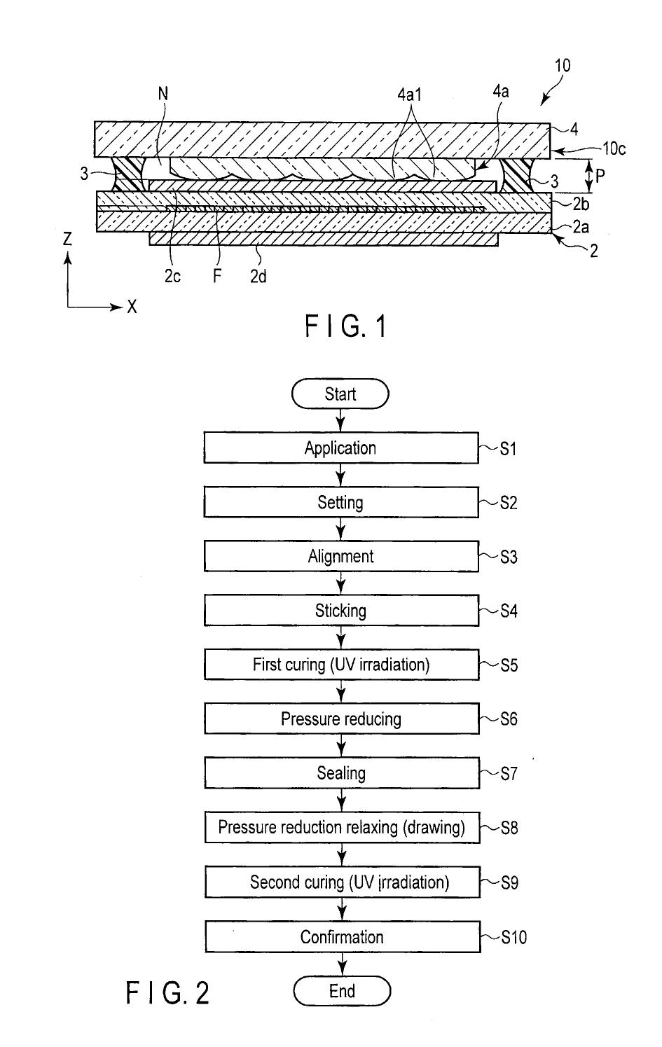

Hereinafter, a three-dimensional image display device 10 and manufacturing method of the three-dimensional image display device 10 according to a first embodiment will be described with reference to FIGS. 1 to 8. In each figure, the configuration is schematically shown by appropriately enlarging, reducing or abbreviating the configuration.

The three-dimensional image display device (hereinafter referred to as a display device) 10 shown in FIG. 1 is provided with a display panel 2 configured to display an image, and lens plate 4 provided on the display panel 2 through an adhesive member 3, and including a lenticular lens on the display panel 2 side. An enclosed space N which is an internal space defined by the display panel 2, adhesive member 3, and lens plate 4 is airtightly sealed, and the enclosed space N is in an airtight state where the internal pressure thereof is lower than the atmospheric pressure.

The display panel 2 is provided with a first substrate 2a serving as a back surface substrate such as an array substrate, and second substrate 2b serving as a front surface substrate. Inside the display panel 2, a plurality of pixels are arranged in a predetermined pattern in, for example, a matrix (lattice) form. As such a display panel 2, for example, a liquid crystal display panel is used. Between the first substrate 2a and second substrate 2b, a liquid crystal layer (not shown) is provided and, on the outer surfaces of the display panel 2, two polarizing plates 2c and 2d are provided. These polarizing plates 2c and 2d are arranged on the display panel 2 opposite to each other.

The first substrate 2a is, for example, a rectangular glass substrate. On the inner surface (surface opposed to the second substrate 2b: top surface in FIG. 1) of the first substrate 2a, a plurality of pixel electrodes, electric wiring configured to supply a potential to these electrodes, and the like are provided. Each of the pixel electrodes is provided in a form of a dot (punctuate form) for each pixel, and the electric wiring is provided in a matrix (lattice) form. The second substrate 2b is, for example, a rectangular glass substrate. On the inner surface (surface opposed to the first substrate: lower surface in FIG. 1) of the second substrate 2b, a color filter F, counter electrode serving as a common electrode, and the like are provided. The color filter F is constituted of a plurality of pigmented layers (red, green, and blue) provided in a form of dots or stripes, and light blocking layer such as a black matrix.

The adhesive member 3 is a member provided between the display panel 2 and lens plate 4 to surround the lenticular lens 4a, and configured to adhere the display panel 2 and lens plate 4 together. The adhesive member 3 is formed into a rectangular frame-like shape between the display panel 2 and lens plate 4 along, for example, their peripheries. The adhesive member 3 functions as a sidewall configured to join the display panel 2 and lens plate 4 together to thereby form the enclosed space N, and further maintains the airtightness of the enclosed space N. As the adhesive member 3, for example, a photocrosslinkable resin or the like is used, and a ultraviolet curable resin is used in this case.

The lens plate 4 is a lens member such as a lens substrate, lens sheet, and the like including a lenticular lens 4a configured to create a three-dimensional image. The lens plate 4 is, for example, a rectangular substrate. The lenticular lens 4a is formed by adjacently juxtaposing cylindrical lenses 4a1 each having a shape formed by dividing a circular cylinder into two in the axial direction in a direction (lateral direction) perpendicular to the axial direction (longitudinal direction, i.e., ridgeline direction). Here, the cylindrical lens 4a1 is a lens having a cylindrical shape, and is a lens having a curvature only in one direction, and having one curvature surface. Further, the lenticular lens 4a is fixed to the inner surface of the lens plate 4, and is provided as part of the lens plate 4. It should be noted that the lenticular lens 4a and lens plate 4 may be formed separately and may thereafter be integrated into one body or may be formed as one body from the beginning by using the same material.

In the display device 10, a voltage is applied to a pixel electrode corresponding to each of the pixels arranged in the matrix form in accordance with the image signal (image data), thereby changing the optical characteristics of each of the pixels (liquid crystal layer) and displaying an image. Particularly, the display device 10 uses the integral imaging system to display a plurality of parallax images (two-dimensional images) delicately different from each other in vision depending on the viewing angle and form a three-dimensional image. The three-dimensional image is an image which is natural, is easy to view, and hardly makes the viewer tired and, furthermore, the range in which such a three-dimensional image can be viewed becomes continuous.

Next, a manufacturing method of the display device 10 will be described below with reference to FIGS. 2 to 9. The manufacturing method of the display device 10 includes, as shown in FIG. 2, as an example, an application process (S1), mounting process (S2), alignment process (S3), adhesion process (S4), first curing process (S5), pressure reduction process (S6), sealing process (S7), pressure reduction relaxation (drawing) process (S8), second curing process (S9), and confirmation process (S10).

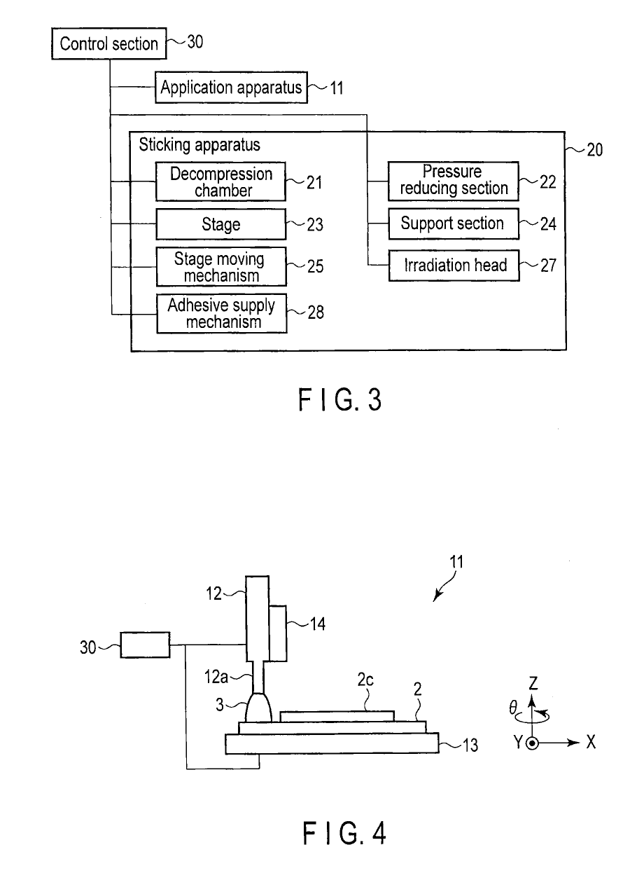

A manufacturing equipment used for the manufacturing method is constituted of, as shown in FIG. 3, an application apparatus 11, adhesion apparatus 20 and, furthermore control section 30 configured to control these apparatuses.

The application apparatus 11 shown in FIG. 4 is provided with an application head 12 configured to discharge an adhesive member 3 from a nozzle 12a. The application head 12 accommodates the adhesive member 3 therein, and discharges the adhesive member from the nozzle 12a communicating with the inside of the head 12. A laser displacement gage 14 which is a noncontact displacement gage utilizing laser is attached to the application head 12.

In the application process (S1), the adhesive member 3 serving as an adhesive is applied to the display panel 2 by using the application apparatus 11. More specifically, a stage 13 on which the display panel 2 is placed is moved in the X and Y directions with respect to the application head 12 configured to discharge the adhesive member 3 from the nozzle 12a, whereby the adhesive member 3 is applied to the display panel 2 placed on the stage 13. When the application is to be carried out, the application gap between the nozzle 12a of the application head 12 and display panel 2 on the stage 13 is measured. The application gap is used in the feedback control to be carried out by the control section 30 of the application apparatus 11, whereby the application gap between the nozzle 12a of the application head 12 and display panel 2 on the stage 13 is maintained constant. Here, it is possible, as described previously, to apply the adhesive member 3 to the lens plate 4 in advance as the need arises.

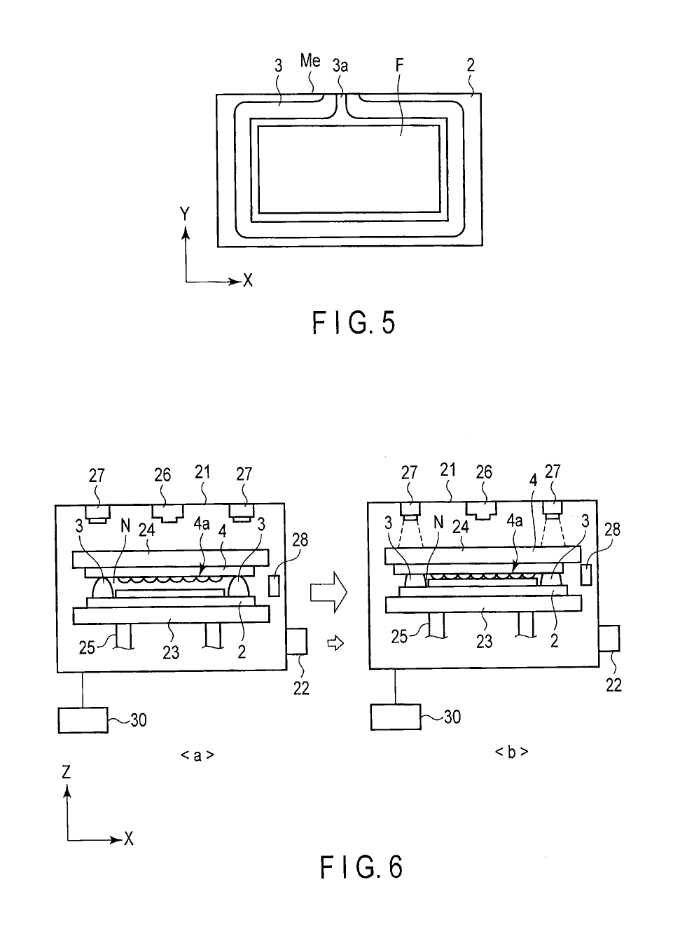

As shown in FIG. 5, in the application process, an adhesive member 3 having a shape of a discontinuous frame is applied to an edge part on the top surface of the display panel 2. That is, in the frame-shaped adhesive member 3, one discontinuous part 3a is formed at a predetermined position of the frame-like shape. The discontinuous part 3a is formed by, for example, reducing the application amount or by stopping the application. For example, the application is started at the discontinuous part 3a, application is then carried out along the edge of the display panel 2, and application is terminated at the discontinuous part 3a, whereby the adhesive member 3 is applied in the frame-like form excluding the discontinuous part 3a. When the display panel 2 and lens plate 4 are adhered together, the discontinuous part 3a forms an aperture 31 through which the internal space N and outside communicate with each other.

As shown in FIG. 6, the adhesion apparatus 20 is provided with, for example, an openable/closable decompression chamber 21, and pressure reduction section 22 configured to adjust the pressure inside the decompression chamber 21. Inside the decompression chamber 21, a stage 23 on which the display panel 2 is to be placed, support section 24 configured to support the lens plate 4, and stage moving mechanism 25 are provided. Furthermore, the decompression chamber 21 is provided with an imaging section 26 configured to carry out imaging at the time of alignment, irradiation heads 27 for light irradiation, and adhesive supply mechanism 28 for sealing.

As the mounting process (S2), the display panel 2 to which the adhesive member 3 has already been applied, and lens plate 4 are mounted. First, the display panel 2 to which the adhesive member 3 has already been applied is placed on the stage 23 provided inside the decompression chamber 21. Subsequently, the lens plate 4 is attached to the support section 24 configured to support the lens plate 4 at a predetermined height by opposing the plate 4 to the stage 23 with the lenticular lens 4a directed to the display panel 2 placed on the stage 23. The stage 23 retains the display panel 2 by means of a retention mechanism utilizing suction attraction, electrostatic attraction or the like.

In the alignment process (S3), alignment of the display panel 2 with the lens plate 4 is carried out. In the alignment process, the stage moving mechanism 25 configured to move the stage 23 in the X, Y, Z, and directions, and imaging section 26 configured to carry out an imaging operation are used. An image for alignment is obtained by the imaging section 26, the display panel 2 on the stage 23 is moved by the stage moving mechanism 25 on the basis of the image, and alignment of the display panel 2 with the lens plate 4 supported by the support section 24 is carried out. Here, the alignment of the display panel 2 with the lens plate 4 is carried out in such a manner that a deviation of the display panel 2 in relative position in the planar direction from the lenticular lens 4a is within a permissible range (for example, within the range of a target value plus or minus several microns).

As shown in FIG. 6, as the adhesion process (S4), the display panel 2 and lens plate 4 are opposed to each other, the stage 23 is upwardly moved by the stage moving mechanism 25, and the display panel 2 on the stage 23 is pressed against the lens plate 4.

When the display panel 2 comes close to the lens plate 4, first, the space N is created in a state where the display panel 2 and lenticular lens of the lens plate 4 are separate from each other (see the left-side view of FIG. 6), and thereafter, when the display panel 2 further comes closer to the lens plate 4, the volume (capacity) of the enclosed space N becomes smaller correspondingly, whereby adhesion of the display panel 2 and lens plate 4 to each other is carried out (see the right-side view of FIG. 6).

It should be noted that, at this point of time, the enclosed space N communicates with the outside through the aperture 31 formed at the discontinuous part 3a, and air can pass through the aperture 31.

In the first curing process (S5), the adhesive member 3 existing between the display panel 2 and lens plate 4 which are in the adhesion-completed state is cured by the plurality of irradiation heads 27 configured to apply ultraviolet light for curing of the adhesive member.

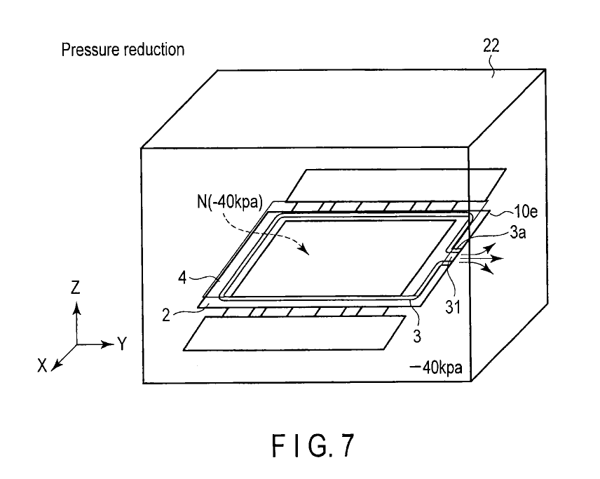

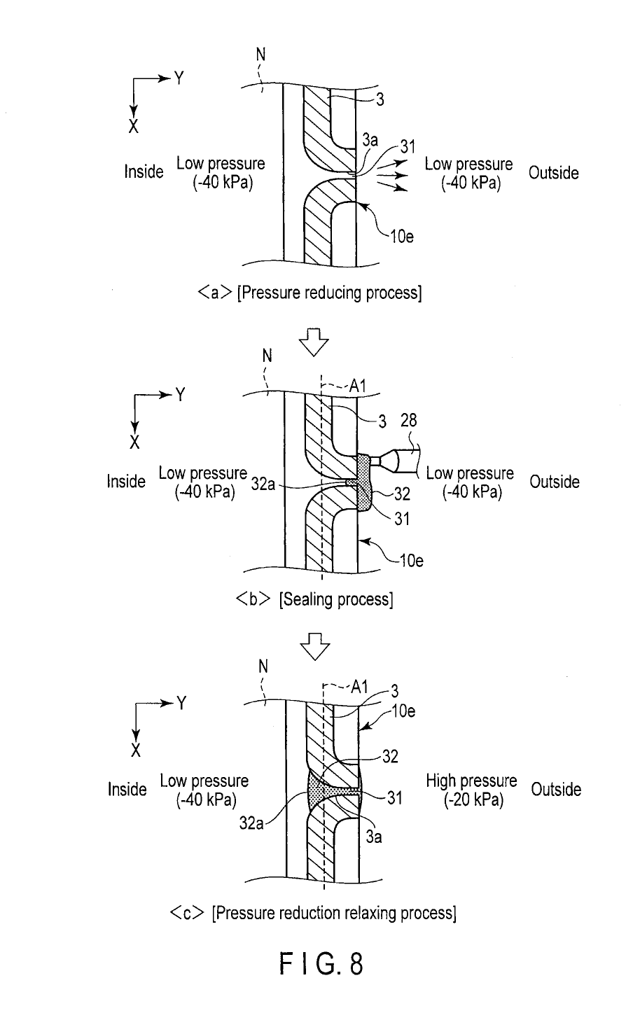

In the pressure reduction process (S6), the decompression chamber 21 is brought to a closed state, and then the atmosphere inside the decompression chamber 21 is discharged from the decompression chamber 21 by the pressure reduction section 22 configured to reduce the pressure inside the decompression chamber 21. The pressure reduction section 22 is constituted of, for example, a vacuum pump and regulator. Thereby, the pressure inside the decompression chamber 21 in the closed state is reduced to a predetermined vacuum pressure by the pressure reduction section 22, and is brought to a pressure state where the pressure is lower than the atmospheric pressure as shown in FIGS. 7 and 8<b>. For example, the pressure inside the decompression chamber 21 is set to −40 kPa.

In the sealing process (S7), inside the decompression chamber 21, an adhesive 32 is supplied by the adhesive supply mechanism 28 such as a syringe or the like, and the adhesive 32 is applied to the aperture 31 from outside the aperture 31 in the reduced pressure atmosphere. As the adhesive 32, at the time of, for example, application, a fluidizable liquid ultraviolet curable resin is used. In the state where the internal pressure of the enclosed space N of the display device 10 is brought to an airtight state where the internal pressure thereof is lower than the atmospheric pressure, the convex parts of the lenticular lens 4a and display panel 2 (polarizing plate 2c) are brought into total contact with each other by the sealing process, and the space N becomes an enclosed space.

The enclosed space N defined by the display panel 2, adhesive member 3, and lens plate 4 is airtightly sealed by the sealing process (S7) with the pressure thereof kept lower than the atmospheric pressure. After the sealing process, the adhesive 32 is arranged in and near the aperture 31 as shown in FIG. 8<b>. It should be noted that in the sealing process (S7), in consideration of the amount of adhesive 32 to be moved in the pressure reduction relaxation process, the application amount of the adhesive is set to a rather greater value. The adhesive 32 to be applied from outside at this point of time is applied to the edge part 10e of each of the display panel 2 and lens plate 4, and hence the adhesive 32 does not reach the predetermined target position A1 set in advance.

In the pressure reduction relaxation process (S8), the pressure-reduced state in the decompression chamber 21 is relaxed (i.e., the pressure inside the decompression chamber 31 is raised) by the pressure reduction section 22, thereby carrying out inward drawing of the adhesive 32. For example, the pressure inside the decompression chamber 21 is raised from −40 to −20 kPa. At this time, the pressure inside the space N still remains at −40 kPa, and the space N is still an enclosed space, and hence a difference between the internal pressure and external pressure is caused by the pressure reduction relaxation. At this time, the frame-shaped adhesive member 3 including the discontinuous part 3a has already been cured, and hence only the fluidizable adhesive 32 arranged at the aperture 31 is inwardly drawn by the pressure difference. As shown in FIG. 8<c>, the adhesive 32 applied to the edge part 10e moves toward the inside through the aperture, whereby the position of the inner end 32a of the adhesive 32 moves toward the inside, and the adhesion area is enlarged. It should be noted that the application amount is set larger in the sealing process (S7), and hence, in the pressure reduction relaxation process (S8), the adhesive 32 inwardly moves while enlarging the adhesion area in a state where the sealed state is maintained as it is.

In the second curing process (S9), the adhesive 32 existing in the aperture 31 (discontinuous part 3a) between the display panel and lens plate 4 is cured by the plurality of irradiation heads 27 configured to apply ultraviolet light for curing of the adhesive member 32, the aperture 31 being in a sealed state. Further, as the confirmation process (S10), confirmation of the drawing position of the adhesive 32 is carried out by, for example, visual inspection or image detection, whereby the three-dimensional image display device is completed. It should be noted that the confirmation process (S10) may be carried out at the stage before the adhesive 32 is cured. After this, the inside of the decompression chamber 21 is opened to the atmosphere, and the display device 10 is taken out.

According to this embodiment, in the sealing process (S7) carried out after the pressure reduction process (S6), the structure in which the display panel 2 and lens plate 4 are adhered together is in a state where the adhesive 32 is applied to the edge part 10e. Further, thereafter, when the pressure reduction relaxation of the circumference (i.e., the pressure of the circumference is raised) is carried out in the pressure reduction relaxation process (S8), the position of the adhesive 32 at the inner end 32a thereof moves to the predetermined position closer to the enclosed space N side by a desired value (see FIG. 8<c>). In the pressure reduction relaxation process (S8), it can be seen that in the manner described above, the adhesion area at the discontinuous part 3a can be enlarged and, regarding the structure in which the display panel 2 and lens plate 4 are adhered together, high adhesion can be secured.

According to the manufacturing method of the three-dimensional image display device associated with this embodiment, it is possible to secure adhesion in the three-dimensional image display device by a simple manufacturing method. That is, the display panel 2 and lens plate 4 are adhered together through the adhesive member 3, the inner space is sealed in the pressure-reduced state and, thereafter the adhesive for sealing is inwardly drawn by the pressure reduction relaxation, whereby high adhesion can easily be secured. That is, even when the gap and aperture are small, it is easily possible to secure adhesion by the pressure difference. Further, the above procedure can be carried out merely by adjusting the pressure-reduced state, and hence it is easily possible to realize the manufacturing method without newly adding any equipment.

In the display device manufactured by the manufacturing method of the three-dimensional image display device according to this embodiment, high adhesion is secured, and the pressure difference between the internal pressure and atmospheric pressure is sufficient, and hence the adhesion state can be maintained even after the manufacture of the device. Accordingly, it becomes possible to prevent the gap from being changed by flexure caused by the device's own weight, local application of pressure from outside, a rise in the ambient temperature or the like, and hence it is possible to maintain the accuracy in the gap between the display panel 2 and lens plate 4, i.e., the accuracy in the clearance between the pixel and lens. Therefore, it becomes possible to maintain the gap accuracy even in, for example, a display device large in size, and significantly affected by environmental changes.

### Second Embodiment

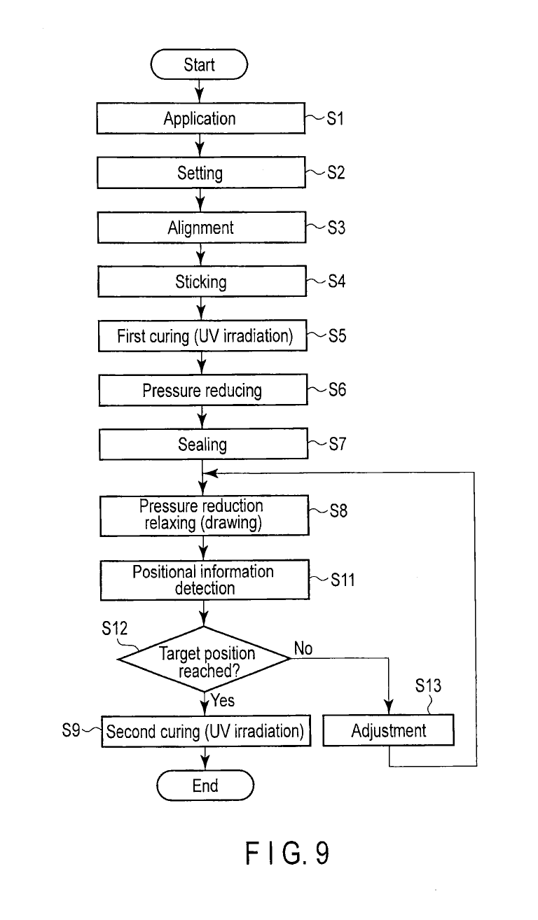

Next, a second embodiment will be described below with reference to FIGS. 9 to 11. It should be noted that the second embodiment is identical to the first embodiment described previously except that a pressure reduction relaxation process is feedback-controlled on the basis of position detection of an adhesive 32, and hence an explanation of common parts will be omitted.

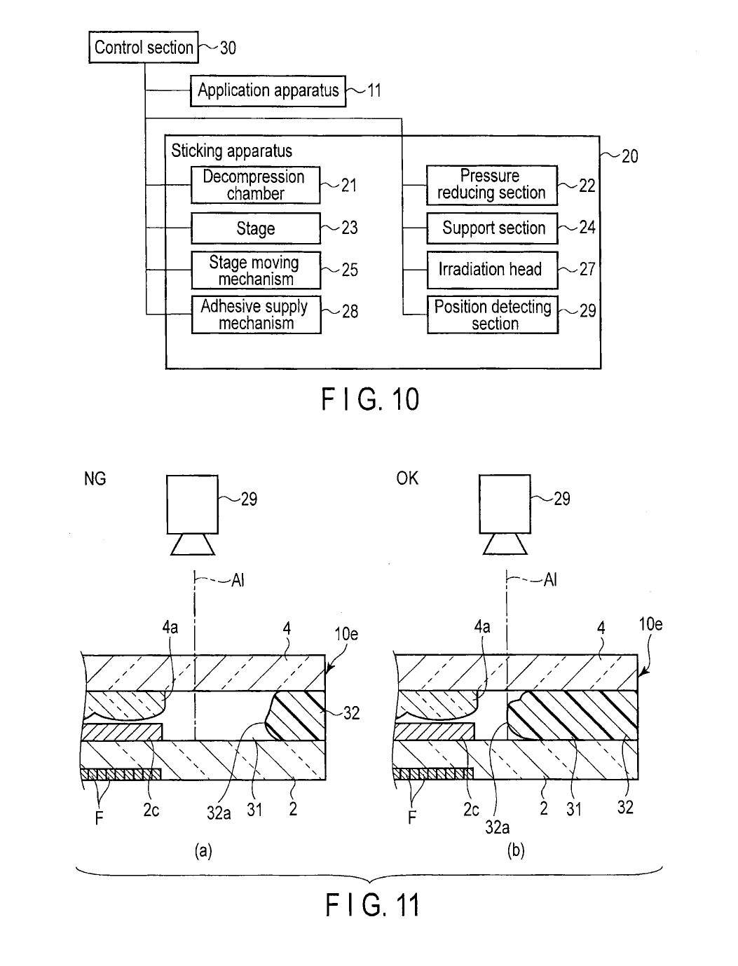

In a manufacturing equipment of the second embodiment, a position detection section 29 configured to detect the position of the adhesive 32 is provided in a decompression chamber 21 as shown in FIGS. 10 and 11. The position detection section 29 is constituted of, for example, a camera, sensor or the like configured to carry out image detection by imaging.

In a manufacturing method of a three-dimensional image display device according to this embodiment, as shown in FIG. 9, in place of the confirmation process (S10) according to the first embodiment described previously, a control section 30 detects, before the second curing process, positional information about the drawing position of the adhesive 32 by means of the position detection section 29 (S11), determines whether or not the adhesive has reached the target position A1 on the basis of the detection result (S12), continues inward drawing of the adhesive 32 to be carried out by pressure reduction relaxation until the adhesive 32 reaches the target position A1 and, as the need arises, feedback-controls the pressure reduction relaxation operation to adjust the pressure of the pressure reduction relaxed state (S13). For example, when the inward drawing of the adhesive 32 is not carried out sufficiently, adjustment of further raising the pressure inside the decompression chamber 21 is carried out, thereby promoting the inward drawing by increasing the pressure difference.

In this embodiment too, an advantage identical to that of the manufacturing method according to the first embodiment is obtained. Furthermore, in the second embodiment, feedback control of the pressure reduction relaxation operation based on position detection is carried out, whereby it becomes possible to secure adhesion area more reliably.

Although in the embodiment described above, the case where each of the discontinuous part 3a and aperture 31 is formed at one position has been exemplified, each of them may be formed at a plurality of positions.

In the embodiments, according to at least one of them described above, it is possible, regarding the three-dimensional image display device, to carry out setting of the distance between the lens plate and display panel with high accuracy, and enhance the adhesion of the adhered structure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of manufacturing a three-dimensional image display device comprising:
supplying an adhesive member to at least one of a lens plate including a lenticular lens, and a display panel configured to display an image in a frame shape including a discontinuous part in such a manner that an aperture is formed in a state where the lens plate and the display panel are adhered together;
adhering the lens plate, and the display panel together through the adhesive member with the lenticular lens directed to the display panel; and
sealing the aperture by supplying an adhesive to the aperture in a reduced pressure atmosphere in the state where the lens plate and the display panel are adhered together, the pressure of the reduced pressure atmosphere being raised after the sealing.

2. The method of manufacturing a three-dimensional image display device according to claim 1, wherein when the pressure of the reduced pressure atmosphere is raised, a position of the adhesive supplied to the aperture is detected, and
the pressure raising operation is controlled on the basis of the detection result.

3. The method of manufacturing a three-dimensional image display device according to claim 1, wherein the adhesive is a photocrosslinkable adhesive, and after the pressure of the reduced pressure atmosphere is raised, the adhesive is cured by light irradiation.

4. The method of manufacturing a three-dimensional image display device according to claim 1, wherein the discontinuous part is a part in which the application amount of the adhesive member is smaller than the other part or the adhesive member is not applied, and which forms an aperture at the time of the adhesion between the lens plate and the display panel opposed to each other.

5. The method of manufacturing a three-dimensional image display device according to claim 1, comprising:
curing, after supplying an adhesive member in a frame shape including a discontinuous part, the frame-shaped adhesive member including the discontinuous part;
carrying out the adhesion after curing the frame-shaped adhesive member;
supplying an adhesive from the outer circumferential side of the panel to the aperture formed by the adhesion in a reduced pressure atmosphere to thereby carry out the sealing;
raising the pressure of the reduced pressure atmosphere after the sealing to thereby draw the supplied adhesive toward the inside of the panel; and
curing the adhesive supplied to the aperture by light irradiation after raising the pressure of the reduced pressure atmosphere.
